(19) United States
(12) Patent Application Publication
(10) Pub. No.: US 2016/0012024 A1
(43) Pub. Date: Jan. 14, 2016

(54) METHOD AND SYSTEM FOR AUTOMATIC GENERATION AND VALIDATION OF HTML5 COMPLIANT SCRIPTS

(71) Applicant: Cognizant Technology Solutions India Pvt. Ltd., Chennai, TN (US)

(72) Inventors: Ramagoppalun Jayaraman, Coimbatore (IN); Karthikeyan Kasthuriswamy, Coimbatore (IN); Madhusudhanan Padmanabhan, Coimbatore (IN); Sivasubramanian Dharmarajan, Coimbatore (IN); Dinesh Babu Thangavel, Tiruppur (IN); Prakasham Selamban, Pin (IN)

(21) Appl. No.: 14/481,175

(22) Filed: Sep. 9, 2014

(30) Foreign Application Priority Data
Jul. 8, 2014 (IN) 3376/CHE/2014

(51) Int. Cl. G06F 17/22; H04L 29/08; G06F 17/30

(52) U.S. Cl. CPC G06F 17/2247; G06F 17/30905; H04L 67/02

(57) ABSTRACT

In accordance with an aspect of the present invention, a system and method for automated processing of electronic documents is provided. The system comprising, an analyzer module, wherein the analyzer module that receives the non-HTML5 input scripts, preliminarily examines the input scripts and extracts critical markup information contained therein; and a compliance module, logically connectible with the analyzer module, configured to transform the non-HTML5 input scripts into one or more equivalent HTML5 output scripts, and post-validate the equivalent HTML5 output scripts by (a) checking that the HTML5 tags present in the equivalent HTML5 output scripts are W3C compliant, and (b) sanctioning Cross Browser backward compatibility by injecting Poly Fills into the equivalent HTML5 output scripts; wherein the analyzer module and the compliance module work in conjunction with a dynamic rule book comprising one or more markup rules in accordance with which one or more actions are performed by the analyzer module and/or the compliance module.

### CROSS REFERENCE TO RELATED APPLICATION

This application is related to and claims the benefit of Indian Patent Application No. 3376/CHE/2014 filed on 8 Jul. 2014, the contents of which are incorporated by reference in their entirety.

### FIELD OF THE INVENTION

This invention relates, generally, to the field of generating HTML5 compliant documents and more particularly, to the field of accepting pre-HTML5 based legacy web application scripts and automatically converting them into HTML5 complaint formats.

### BACKGROUND OF THE INVENTION

In recent times HTML5 has become the preferred markup script option of most web applications. Furthermore, as the technology is maturing, said HTML5 format is becoming more and more popular and is acquiring standard status. Adoption and compliance with HTML5 i.e. effective conversion of pre-HTML5 applications to HTML5 consistent applications, therefore, has become a necessary requirement of the IT Business Industry.

Conventionally various systems and methods are known in the art that cater to the needs of the users in this space. For example, one class of markup converters may provide for upgrading pre-HTML5 scripts to contemporaneous HTML5 formats subject to one or more conditions or constraints. Some of these constraints or conditions may include placing a limit on the number of lines of the input script or placing a restriction on the input script type (e.g. input script should be ‘XML only’) etc. In case, said one or more conditions or constraints are not met then said markup converters will fail to operate.

One other class of the state-of-the-art markup converters may facilitate uploading Pre-HTML5 applications in a third party environment i.e. said markup converters may require the input scripts of Pre-HTML5 applications to be moved out of enterprise premises and submitted in an alien environment e.g. online third party tools. In such cases, due to absence of control and supervision, there may always be a possibility of script theft, script mutilation or destruction and/or any other way of compromising the integrity and security of the script.

Additionally, a disadvantage common to all the classes of markup converters is that these markup converters cease to operate as soon as the conversion to HTML5 is completed. None of the markup converters known in the art make the extra effort of verifying whether or not the newly generated HTML5 scripts run properly with HTML5 non-compatible Browsers i.e. the known markup converters do not account for Cross-Browser Backward Compatibility.

Based on the classes of markup converters discussed above, it may be understood by a person skilled in the art that there is a need of providing a dynamic ‘one-stop solution’ which can provide extensive HTML5 conversion without being restricted by conditions or constraints. Additionally, the need is also to provide a solution which facilitates ‘on-premise conversion’ i.e. the solution should be deployable in the premises of the Legacy applications itself so that integrity and security of the script(s) is not compromised. Also, the need is to provide a markup converter that facilitates Cross Browser Backward Compatibility so that both, the HTML5 compliant Browsers as well as the HTML5 non-complaint browsers may make use of the HTML5 complaint scripts generated thereof. The instant invention aims at realizing the aforesaid disadvantages by offering a solution in accordance with the manner described.

### SUMMARY OF THE INVENTION

The present invention is intended to address at least the above-mentioned problems and/or disadvantages and to provide a suitable solution. Accordingly, an aspect of the present invention is to provide a system, method and computer program product for automatic generation and validation of HTML5 complaint applications.

In accordance with an aspect of the present invention, an automatic markup converter is provided, wherein the markup converter comprises an analyzer module, wherein the analyzer module receives one or more non-HTML5 input scripts from a legacy application, and examines, preliminarily, the one or more non-HTML5 input scripts and extracts critical markup information pertaining to the HTML5 non-compliant tags committed in the input scripts. Furthermore, the automatic markup converter also comprises a compliance module, logically connectible with the analyzer module, wherein the compliance module transforms the one or more non-HTML5 input scripts into one or more equivalent HTML5 output scripts, and post-validates the one or more equivalent HTML5 output scripts by (a) checking that the HTML5compliant tags present in the one or more equivalent HTML5 output scripts are W3C compliant, and (b) sanctioning Cross Browser backward compatibility by injecting Poly Fills into the one or more HTML5 output scripts; wherein the analyzer module and the compliance module work in conjunction with a dynamic rule book, further wherein the dynamic rule book comprises one or more markup rules in accordance with which one or more actions are performed by the analyzer module and/or the compliance module.

In accordance with one other aspect of the present invention, a method of automated processing of electronic documents is provided, wherein the method comprises, receiving one or more non-HTML5 input scripts from a legacy application; examining, preliminarily, the one or more input scripts and extracting critical markup information pertaining to the HTML5 non-compliant tags committed in the input scripts; transforming the one or more non-HTML5 input scripts into one or more equivalent HTML5 output scripts; and post-validating the one or more equivalent HTML5 output scripts by (a) checking that one or more HTML5 tags present in the one or more HTML5 output scripts are W3C compliant, and (b) sanctioning Cross Browser backward compatibility by injecting Poly Fills into the one or more HTML5 output scripts.

In accordance with another aspect of the present invention, a computer program product comprising a non-transitory computer-readable medium having computer-readable program code stored thereon, is provided. The computer-readable program code comprising instructions that, when executed by a processor, cause the processor to trigger an automatic markup converter, wherein the markup converter comprises an analyzer module, wherein the analyzer module receives one or more non-HTML5 input scripts from a legacy application, and examines, preliminarily, the one or more non-HTML5 input scripts and extracts critical markup information pertaining to the HTML5 non-compliant tags committed in the input scripts. Furthermore, the automatic markup converter also comprises a compliance module, logically connectible with the analyzer module, wherein the compliance module transforms the one or more non-HTML5 input scripts into one or more equivalent HTML5 output scripts, and post-validates the one or more equivalent HTML5 output scripts by (a) checking that the HTML5compliant tags present in the one or more equivalent HTML5 output scripts are W3C compliant, and (b) sanctioning Cross Browser backward compatibility by injecting Poly Fills into the one or more HTML5 output scripts; wherein the analyzer module and the compliance module work in conjunction with a dynamic rule book, further wherein the dynamic rule book comprises one or more markup rules in accordance with which one or more actions are performed by the analyzer module and/or the compliance module.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE ACCOMPANYING FIGURES

The above and other aspects, features, and advantages of certain exemplary embodiments of the present invention will be more apparent from the following detailed description taken in conjunction with the accompanying drawings, in which:

FIG. 1 illustrates a block diagram of a preferred embodiment of the automated markup converter in accordance with the invention;

FIG. 2 illustrates a preferred embodiment of the analyzer module;

FIG. 3 illustrates a preferred embodiment of the compliance module;

FIG. 4 illustrates a method for automatic markup conversion in accordance with the invention;

FIG. 5 illustrates a preferred embodiment of the step of examining, preliminarily, the input scripts and extracting critical markup information committed therein;

FIG. 6 illustrates a preferred embodiment of the step of transforming the non-HTML5 input scripts into equivalent HTML5 output scripts;

FIG. 7 illustrates a preferred embodiment of the step of perusing the non-HTML5 input scripts and identifying code snippets therein;

FIG. 8 illustrates a preferred embodiment of the step of generating an equivalent HTML5 compliant tag for each of the read HTML5 non-compliant tags;

FIG. 9 illustrates a preferred embodiment of the step of developing CSS files in compliance with CSS3 specification, and linking the generated CSS files with the HTML5 output scripts;

FIG. 10 illustrates a preferred embodiment of the step of post-validating the HTML5 output scripts by checking for W3C compliance;

FIG. 11 illustrates a preferred embodiment of the step of post-validating the HTML5 output scripts by sanctioning cross-browser backward compatibility; and

FIG. 12 illustrates a computer program product for implementing the system in accordance with this invention.

### DETAILED DESCRIPTION OF THE INVENTION

The following description with reference to the accompanying drawings is provided to assist in a comprehensive understanding of exemplary embodiments of the invention as defined by the claims and their equivalents. Those skilled in the art would appreciate that the following description is for illustration purpose only and not for the purpose of limiting the invention as defined by the appended claims and their equivalents. Those of ordinary skill in the art will also understand that various changes and modifications of the embodiments described herein may be made without departing from the scope and spirit of the invention.

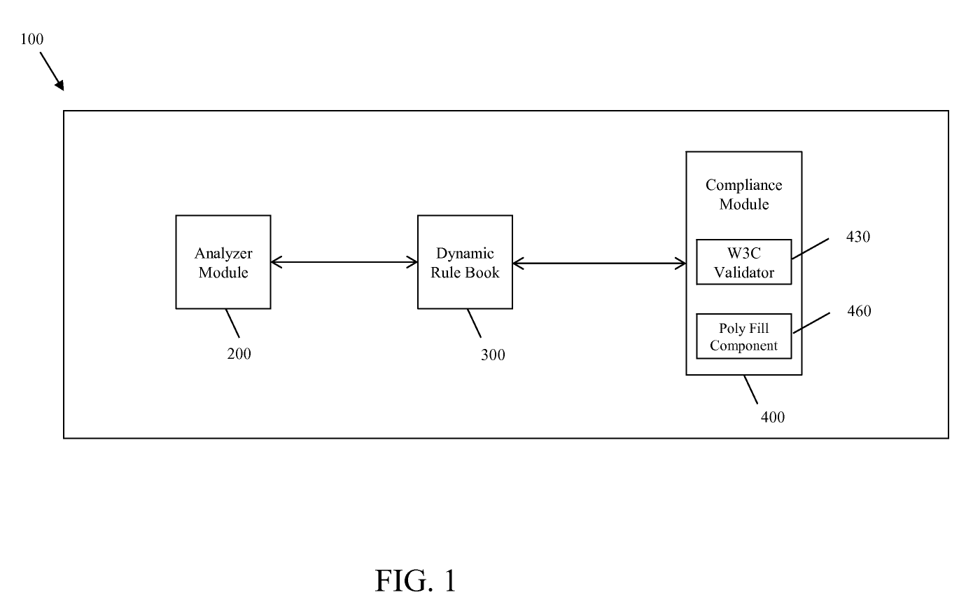

Additionally, the terms and words used in the following description and claims are not limited to the bibliographical meanings, but, are merely used by the inventor to enable a clear and consistent understanding of the invention. It is to be understood that the singular forms “a,” “an,” and “the” include plural referents unless the context clearly dictates otherwise. FIGS. 1 to 12, discussed below, and the various embodiments used to describe the principles of the present disclosure in this patent document are by way of illustration only and should not be construed in any way that would limit the scope of the disclosure.

FIG. 1 illustrates a high-level block diagram of a preferred embodiment of a system in accordance with the invention [100]. In accordance with the preferred embodiment, the illustrated markup converter [100], largely comprises an analyzer module [200] which in the broadest sense, is configured to receive one or more non-HTML5 input scripts from a legacy application, and obtain crucial markup information from the one or more input scripts received thereof; a compliance module [400] which in the broadest sense, is configured to convert one or more non-HTML5 input scripts into one or more equivalent HTML5 output scripts, and validate the newly generated one or more equivalent HTML5 output scripts; and a dynamic rule book [300] which contains an exhaustive set of markup rules and is configured to work in conjunction with the analyzer module [200] and the compliance module [400]. These rules contained in the dynamic rule book [300] may relate to various aspects of markup conversion such as rules for checking whether a markup tag is HTML5 compliant or not, rules for transforming HTML5 non-compliant tags to HTML5 compliant tags, rules for verifying W3C standard compliance, rules for identifying poly fills etc.

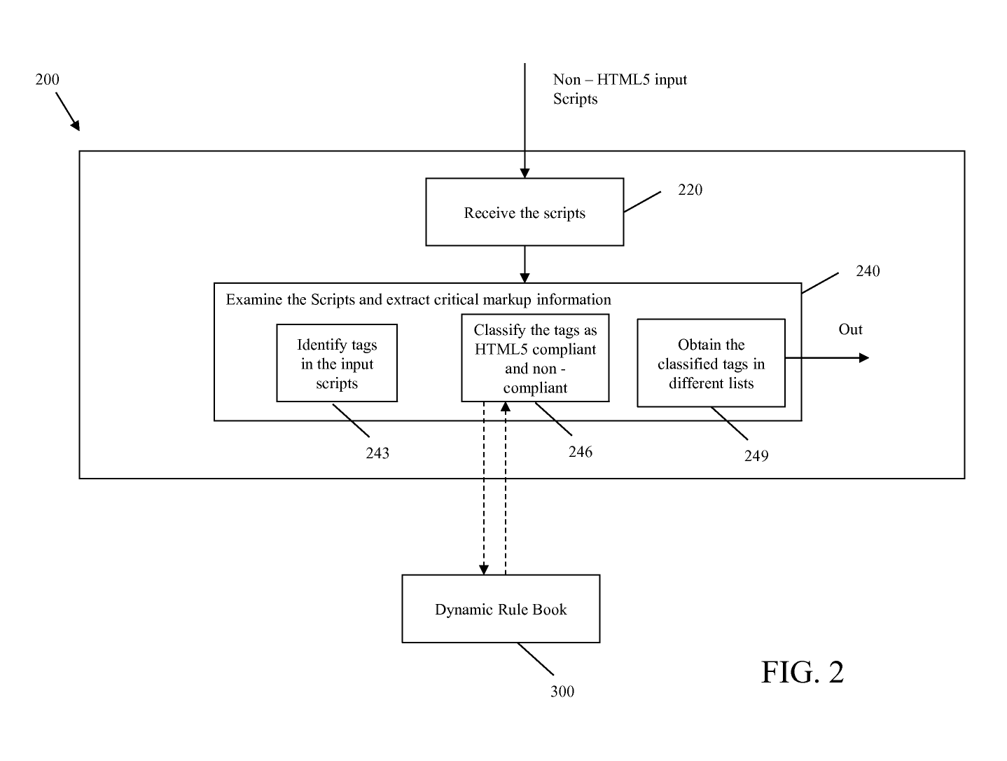

FIG. 2 substantiates upon a preferred embodiment of the first major module within claimed markup converter [100], namely the analyzer module [200]. In accordance with FIG. 2, the analyzer module [200] is largely configured to receive one or more input scripts [220]. These input scripts so received may be a non-HTML5 static script such as a static HTML script or a Java script, or a non-HTML5 dynamic script such as a server side scripts in J2EE and .NET or a Free Marker scripts, and may correspond to file formats including .jsp, .html, .ftl, .asp, .aspx, .xml, .xsl, .war, .ear, .zip, .ascx, .vb and .js. Additionally, the analyzer module [200] may be configured preliminarily examine, the one or more input scripts to extract critical markup information committed therein [240].

In accordance with FIG. 2, it may be noted that the analyzer module [200] preliminary examines and extracts critical markup information [240], by identifying all the tags in the one or more input scripts by applying at least one of: a pattern matching technique and/or a regex technique [243]. This identification is followed by classifying all the identified tags in the one or more input scripts as HTML5 Compliant Tags and HTML5 Non-Compliant Tags by validating the tags against one or more markup rules stored in the Dynamic Rule Book [246]. Lastly, this classification is followed by receiving the classified tags, separately as two distinct lists and utilizing the lists for one or more purposes including reporting HTML5 compliance status of the one or more input scripts [249].

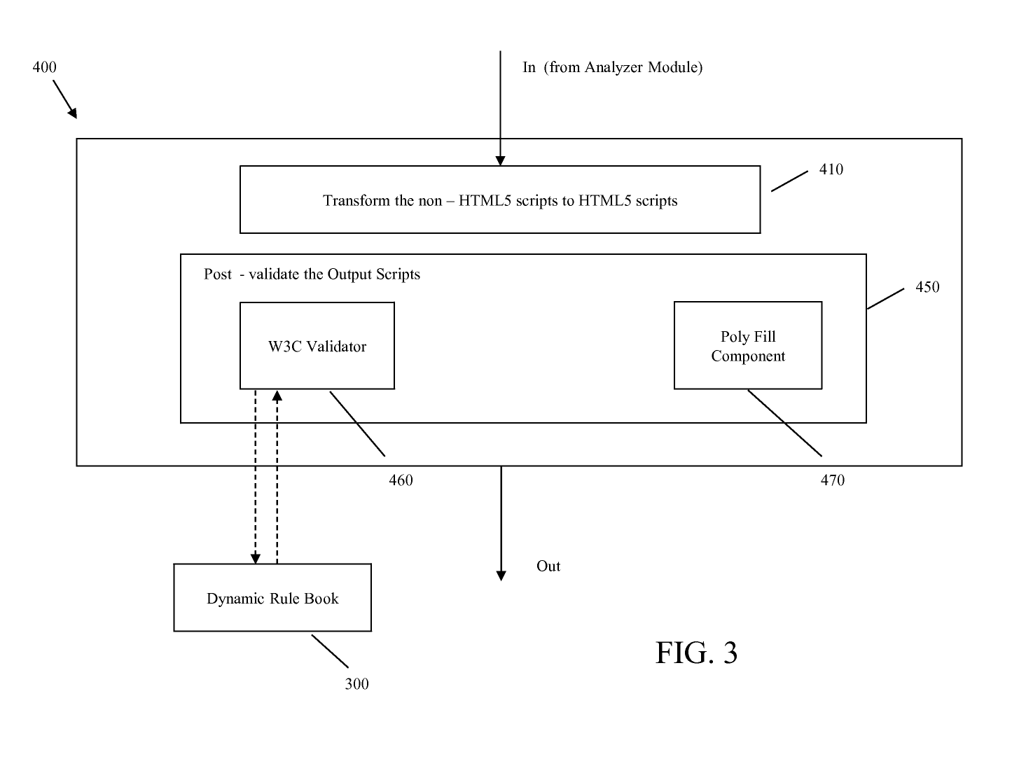

FIG. 3 substantiates upon a preferred embodiment of the second major module within claimed markup converter [100], namely the compliance module [400]. In accordance with FIG. 3, the compliance module [400] is largely configured to transforms the one or more non-HTML5 input scripts into one or more equivalent HTML5 output scripts [410], and post-validates the one or more equivalent HTML5 output scripts [450] by (a) checking that the HTML5 compliant tags present in the one or more equivalent HTML5 output scripts are W3C compliant, and (b) sanctioning Cross Browser backward compatibility by injecting Poly Fills into the one or more HTML5 output scripts;

In accordance with FIG. 3, the transformation of the one or more non-HTML5 input scripts into one or more equivalent HTML5 output scripts [410] may comprise receiving the one or more non-HTML5 input scripts from the analyzer module; Once the input scripts are received, the compliance module [400] may peruse through the one or more non-HTML5 input scripts and identify one or more code snippets. Next, the compliance module [400] may logically separate the one or more identified code snippets from the one or more non-HTML5 input scripts so as to obtain the code snippets and one or more remaining input scripts as distinct inputs; The compliance module [400], may now take up the one or more remaining input scripts (and not the code snippets) and generate an equivalent HTML5 compliant tag for each of the HTML5 non-compliant tags, read from one or more remaining input scripts; Lastly, the compliance module [400] may substitute the one or more HTML5 non-compliant tags in the non-HTML5 input scripts, with the one or more equivalent HTML5 compliant tags generated thereof and, obtain the one or more equivalent HTML5 output scripts; In more sophisticated embodiments of the claimed system [100], the compliance module [400] may, further, be configured develop one or more CSS files in compliance with CSS3 specification, and link the generated CSS files with the HTML5 output scripts. More details on the aforementioned activities, associated with the compliance module [400] will follow in the paragraphs below.

As indicated above, the first activity performed by the compliance module [400] in relation to the transformation of the non-HTML5 input scripts to HTML5 output scripts [410] is that of receiving the input scripts from the analyzer module [200]. As already stated these non-HTML5 input scripts may be a non-HTML5 static script such as a static HTML script or a Java script, or a non-HTML5 dynamic script such as a server side scripts in J2EE and .NET or a Free Marker scripts, and may correspond to file formats including .jsp, .html, .ftl, .asp, .aspx, .xml, .xsl, .war, .ear, .zip, .ascx, .vb and .js.

The second activity performed by the compliance module [400] in relation to the transformation of the non-HTML5 input scripts to HTML5 output scripts [410] is that of perusing the one or more non-HTML5 input scripts and identifying one or more code snippets. These code snippets essentially represent those sections (or tags or cluster of tags) that are not to be transformed by the claimed markup converter [100]. Simply stated, these code snippets represent those sections of a non-HTML5 input script that would appear as it is in the HTML5 output scripts (obtained after markup conversion). Accordingly, a preferred embodiment of the activity of perusing the input scripts and identifying code snippets may comprise the sub-activities of receiving one or more instructions wherein, these instructions may be pre-stored or dynamically obtained instructions from the claimed system [100], or instructions that are manually fed by one or more users and/or operators and/or any other human participants; utilizing the instructions so received, to determine one or more code snippets within the non-HTML5 input scripts; and introducing one or more labels in the non-HTML5 input scripts so as to clearly demarcate the one or more code snippets.

As already stated, the third activity performed by the compliance module [400] in relation to the transformation of the non-HTML5 input scripts to HTML5 output scripts [410] is that of logically separating the one or more identified code snippets from the one or more non-HTML5 input scripts so as to obtain the code snippets and one or more remaining input scripts as distinct inputs. The purpose of this activity is merely to isolate that portion of the input script which is to be subjected to markup conversion i.e. non-HTML5 input script without the code snippets (i.e. the remaining input script). Person skilled in the art will appreciate that in this context, logical separation means that separation which makes the entities, so separated, distinctly identifiable at software level. Said separation does not show any results in real-time/physical environment.

The fourth activity performed by the compliance module [400] in relation to the transformation of the non-HTML5 input scripts to HTML5 output scripts [410] is that of generating an equivalent HTML5 compliant tag for each of the read one or more HTML5 non-compliant tags. A preferred embodiment of this activity may further, include the sub-activities of individually reading, each one or more HTML5 non-compliant tags from the one or more non-HTML5 input scripts. This individual reading of each one or more HTML5 non-compliant tags may be accomplished using at least one of: a pattern matching technique or a regex technique; Next, this activity may comprise converting each of the individually read one or more HTML5 non-compliant tags into one or more equivalent HTML5 compliant tags by applying one or more markup rules from the dynamic rule book. The output of this activity performed by the compliance module [400] would be that each of the HTML5 non-compliant tag present in the non-HTML5 input script would have a corresponding HTML5 compliant tag generated thereof.

The fifth activity performed by the compliance module [400] in relation to the transformation of the non-HTML5 input scripts to HTML5 output scripts [410] is that of substituting the one or more HTML5 non-compliant tags in the non-HTML5 input scripts, with the one or more equivalent HTML5 compliant tags generated thereof. The output of this activity would, therefore, be that one or more equivalent HTML5 output scripts would be obtained.

The HTML5 output script which are obtained as an end result of the fifth activity (explained in the previous paragraph) usually, mark the end of transformation of non-HTML5 input scripts to HTML5 output scripts [410]. However, in sophisticated embodiments of the claimed markup converters [100], the compliance module [400] may perform an additional sixth activity of developing one or more CSS files in compliance with CSS3 specification, and linking the generated CSS files with the HTML5 output scripts. The purpose of this sixth activity is primarily to ensure that the aesthetics of the non-HTML5 input scripts are reflected in the HTML5 output script. Person skilled on the art will appreciate that the purpose of the first five activities within the wider ambit of transforming the non-HTML5 input scripts into the HTML5 output scripts [410] is only to take the content of the non-HTML5 scripts and transform the content into a HTML5 compliant format. Person skilled in the art will appreciate these first five activities do not take into consideration the aesthetics surrounding the translated content i.e. these activities do not account for maintaining the ‘look and feel’ of the HTML5 output script, the formatting of the Output scripts, the arrangement of content in the HTML5 output scripts, the font and stylizing of the content in the Output Scripts etc. It is for this purpose that the sixth activity is performed. In accordance with this activity, the aforesaid styling information of the non HTML5 input script is captured in a CSS file and then linked with the HTML5 output script. This helps in mirroring the ‘look and feel’ of the non-HTML5 input script in the HTML5 output script as well. Accordingly, in a preferred embodiment of this sixth activity, the compliance module [400] may perform the sub-activities of reading the styling information from the one or more non-HTML5 input scripts, wherein the styling information is read from at least one of: a section within the input script or a tag with styling information embedded in it; consolidating the styling information read thereof, into one or more CSS files, wherein the CSS files are in compliance with CSS3 specification; and externalizing the CSS files and linking the CSS files externalized thereof, with the one or more HTML5 output scripts by attaching the context path of the externalized CSS files with the output scripts.

Once the non-HTML5 input scripts are transformed into the HTML5 output scripts then the Compliance module [400] post-validates the HTML5 output scripts which are obtained after the said transformation [450]. In accordance with the invention, this post-validation takes place in two stages. Firstly, a check is made to ensure that the HTML5 output scripts, so generated, are W3C standard compliant [460]. Secondly, the HTML5 output scripts so generated are made cross-browser backward compatibility by injecting ‘poly fills’ into the HTML5 output scripts [470].

As stated, the first stage of post validation [450] is that of checking that the HTML5 output scripts, are W3C standard compliant. Person skilled in the art would acknowledge that the W3C (or the World Wide Web Consortium) is the main organization involved in writing standards for the web, including standards for markup languages. Accordingly, Person skilled in the art would understand that the first stage of post-validation i.e. checking W3C standard compliance [460] would be highly relevant in this context. In a preferred embodiment, checking W3C standard [460] compliance may be done by a W3C Validator [460], wherein the W3C Validator comprises the complete set of W3C standards that are relevant in relation to markup conversion, further wherein the W3C Validator may be configured to read each of the HTML5 Compliant Tags from the HTML5 output Scripts by using at least one of: a pattern matching technique or a regex technique; retrieve W3C standards which are applicable to each of the HTML5 Compliant tags read thereof; test each of the HTML5compliant tags in light of the applicable W3C standards retrieved thereof; and redirect the HTML5 output scripts to the dynamic rule book [300] for correction, in case, the test result for the HTML5 complaint tags is not in confirmation with the one or more applicable standards. In case, the W3C Validator [460] redirects the HTML5 output scripts to the dynamic rule book [300] for correction, the Dynamic rule book [300] would receive the HTML5 output Script which are redirected by the W3C Validator; alter the HTML5 output Scripts and the tags therein, based on the one or more markup rules relating to W3C standard; and push back the altered one or more HTML5 output scripts and the tags therein to the W3C Validator [460].

The second stage of post validation [450] is that of sanctioning cross-browser backward compatibility [470]. Person skilled in the art would acknowledge that cross-browser backward compatibility is necessary for equipping the HTML5 output scripts with the capability of running and executing on HTML5 compatible browsers, as well as the legacy browsers that are not compatible with HTML5. Some of these legacy browsers may include browsers such as include browsers such as Safari 3.1 and Firefox 2.0. Accordingly, person skilled in the art would understand that the second stage of post-validation i.e. sanctioning cross browser compatibility [470] would be highly relevant in this context. In a preferred embodiment, sanctioning cross browser compatibility [470] may be done by a Poly Fill Component [470], wherein the Poly Fill Component [470] receives the one or more HTML5 Output Scripts; identifies one or more Poly fills that apply to each the Output Scripts received thereof, wherein the Polly Fills essentially consist of one or more tags that render the HTML5 Output Scripts workable on legacy browsers; and injects the one or more identified poly fills at appropriate positions within the one or more output scripts.

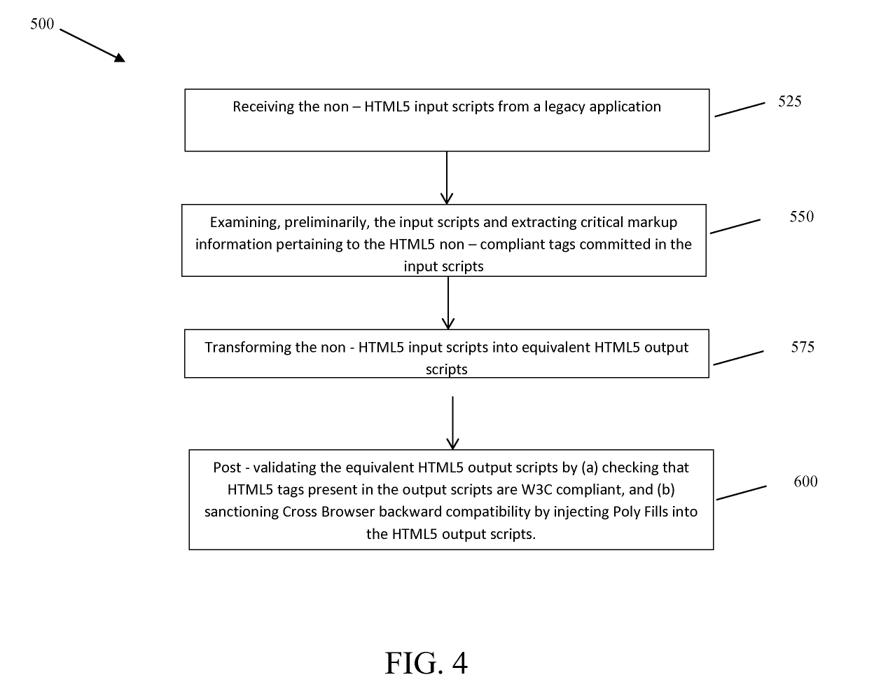

FIG. 4 illustrates a high-level flow chart of a non-limiting, exemplary embodiment of a process for automatic markup conversion [500], wherein the process [500] comprises receiving one or more non-HTML5 input scripts from a legacy application [525]; examining, preliminarily, the one or more input scripts and extracting critical markup information pertaining to the HTML5 non-compliant tags committed in the input scripts [550]; transforming the one or more non-HTML5 input scripts into one or more equivalent HTML5 output scripts [575]; and post-validating the one or more equivalent HTML5 output scripts by (a) checking that one or more HTML5 tags present in the one or more HTML5 output scripts are W3C compliant, and (b) sanctioning Cross Browser backward compatibility by injecting Poly Fills into the one or more HTML5 output scripts.

In accordance with FIG. 4, the step of receiving one or more non-HTML5 input scripts from a legacy application [525] may comprise receiving at least one of: a non-HTML5 static script such as a static HTML script or a Java scripts, or a non-HTML5 dynamic script such as a server side script in J2EE and .NET or Free Marker script, further wherein the non-HTML5 input scripts correspond to file formats including .jsp, .html, .ftl, .asp, .aspx, .xml, .xsl, .war, .ear, .zip, .ascx, .vb and .js.

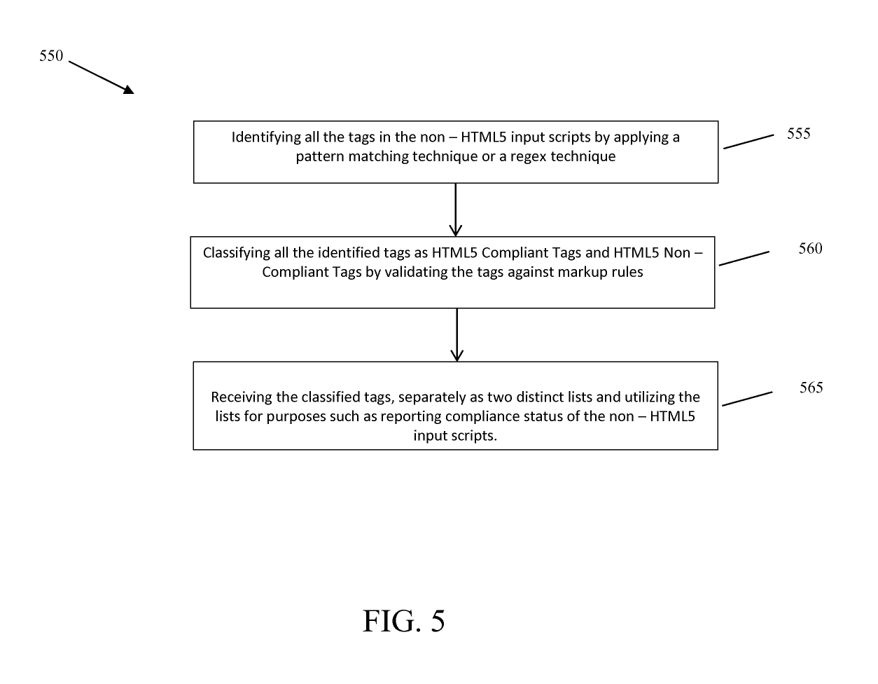

In accordance with the preferred embodiment of FIG. 5, the step of preliminarily examining, the non-HTML5 input scripts and extracting critical markup information [550] comprises identifying all the tags in the one or more non-HTML5 input scripts by applying at least one of: a pattern matching technique or a regex technique [555]; classifying all the identified tags as HTML5 Compliant Tags and HTML5 Non-Compliant Tags by validating the tags against one or more markup rules [560]; and receiving the classified tags, separately as two distinct lists and utilizing the lists for one or more purposes including reporting HTML5 compliance status of the one or more non-HTML5 input scripts [565].

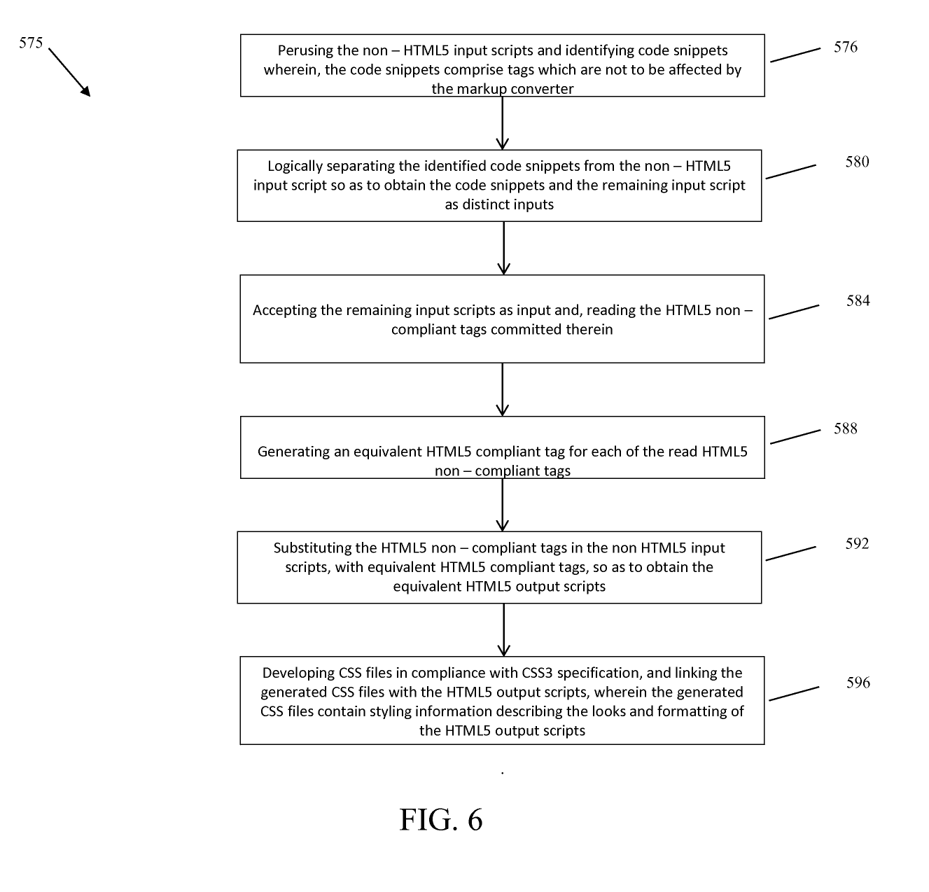

In accordance with the preferred embodiment of FIG. 6, the step of transforming the one or more non-HTML5 input scripts into one or more equivalent HTML5 output scripts [575] comprise the sub steps of perusing the one or more non-HTML5 input scripts and identifying one or more code snippets wherein, the code snippets comprise one or more tags which are not to be affected by the markup converter [576]; logically separating the one or more identified code snippets from the one or more non-HTML5 input scripts so as to obtain the one or more code snippets and the remaining input scripts as distinct inputs [580]; accepting the one or more remaining input scripts as input and, reading the one or more HTML5 non-compliant tags committed therein [584]; generating an equivalent HTML5 compliant tag for each of the read one or more HTML5 non-compliant tags [588]; substituting the one or more HTML5 non-compliant tags in the non HTML5 input scripts, with the one or more equivalent HTML5 compliant tags, so as to obtain the one or more equivalent HTML5 output scripts [592]; and developing one or more CSS files in compliance with CSS3 specification, and linking the generated CSS files with the HTML5 output scripts, wherein the generated CSS files contain styling information describing the looks and formatting of the HTML5 output scripts [596]. More details on each of these sub steps will follow in the paragraphs mentioned below.

As indicated above, the first sub step within the step of transforming of the non-HTML5 input scripts to HTML5 output scripts [575] is that of perusing the one or more non-HTML5 input scripts and identifying one or more code snippets [576]. These code snippets essentially represent those sections (or tags or cluster of tags) that are not to be transformed by the claimed process of markup conversion [500]. Simply stated, these code snippets represent those sections of a non-HTML5 input script that would appear as it is in the HTML5 output scripts (obtained after markup conversion).

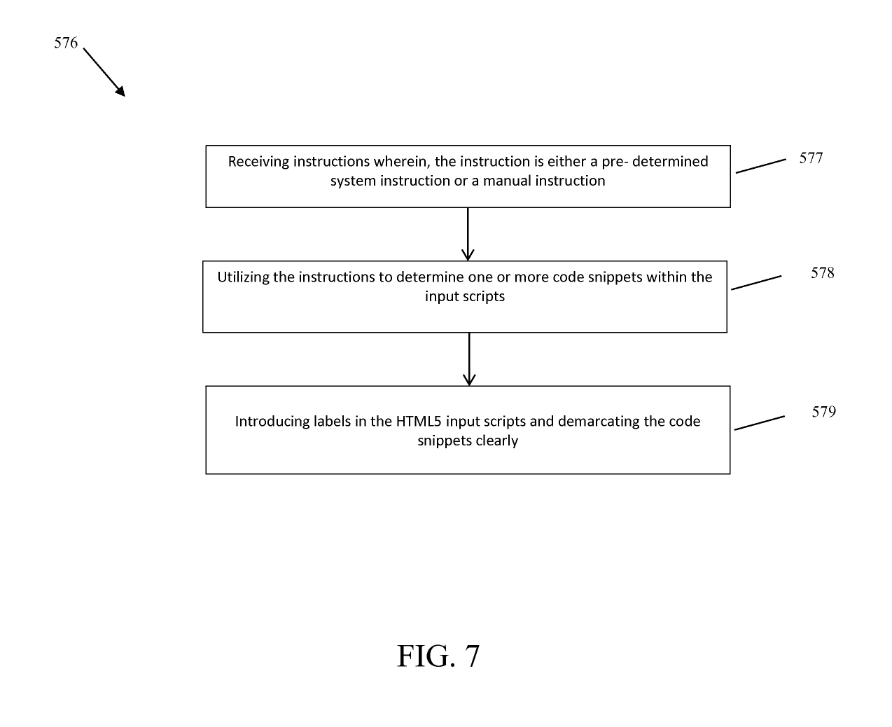

In accordance with the preferred embodiment of FIG. 7, the step of perusing the one or more non-HTML5 non-compliant input scripts and identifying one or more code snippets [576] comprises receiving one or more instructions wherein, the instructions are at least one of: a pre-determined system instruction or a manual instruction [577]; utilizing the one or more instructions to determine one or more code snippets within the input scripts, wherein the code snippets comprise one or more tags that are not to be affected by the markup converter [578]; and introducing one or more labels in the HTML5 input scripts and demarcating, clearly, the one or more code snippets [579].

The next sub step within step of transforming the non-HTML5 input scripts to HTML5 output scripts [575] is that of logically separating the one or more identified code snippets from the one or more non-HTML5 input scripts so as to obtain the code snippets and one or more remaining input scripts as distinct inputs [580]. The purpose of this sub step is merely to isolate that portion of the input script which is to be subjected to markup conversion i.e. non-HTML5 input script without the code snippets (i.e. the remaining input script). Person skilled in the art will appreciate that in this context, logically separating means separating entities and making the entities distinctly identifiable at a software level. Said separation does not show any results in real-time/physical environment.

The next sub step within the step of transforming the non-HTML5 input scripts to HTML5 output scripts [575] is that of accepting the one or more remaining input scripts as input and, reading the one or more HTML5 non-compliant tags committed therein [584].

Once the one or more remaining input scripts are accepted as input and the one or more HTML5 non-compliant tags committed therein are read, the next sub step within the step of transforming the non-HTML5 input scripts to HTML5 output scripts [575] is that of generating an equivalent HTML5 compliant tag for each of the read one or more HTML5 non-compliant tags [588].

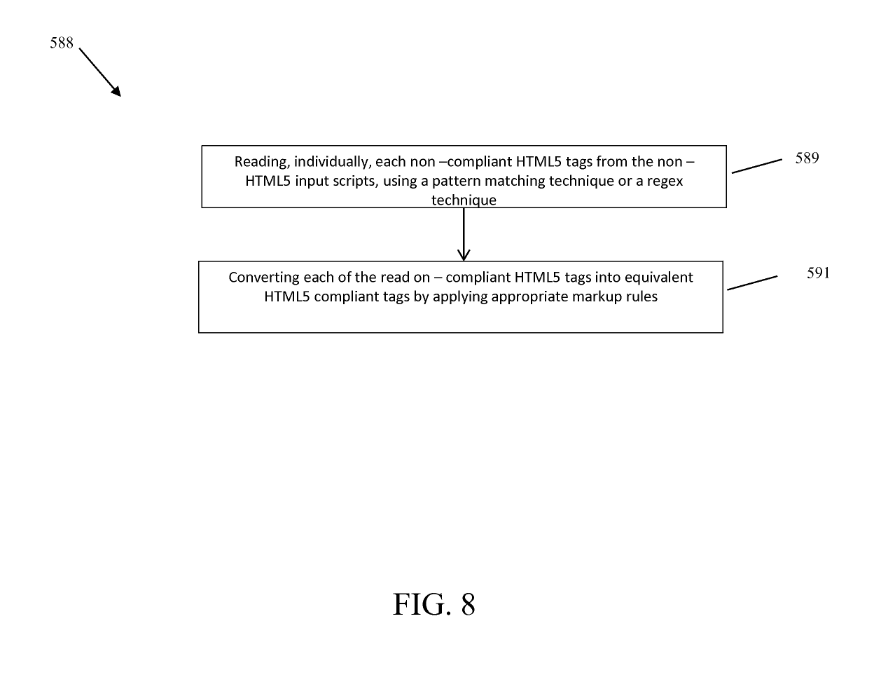

In accordance with the preferred embodiment of FIG. 8, the sub step of generating an equivalent HTML5 compliant tag for each of the read one or more HTML5 non-compliant tags [588] comprises reading, individually, each one or more non-compliant HTML5 tags from the one or more non-HTML5 input scripts, using at least one of: a pattern matching technique or a regex technique [589]; and converting each of the read one or more non-compliant HTML5 tags into one or more equivalent HTML5 compliant tags by applying one or more markup rules [591].

The next sub step within the step of transforming the non-HTML5 input scripts to HTML5 output scripts [575] is that of substituting the one or more HTML5 non-compliant tags in the non-HTML5 input scripts, with the one or more equivalent HTML5 compliant tags generated thereof [592]. The output of this sub step would, therefore, be that one or more equivalent HTML5 output scripts would be obtained.

The substituting of the one or more HTML5 non-compliant tags in the non-HTML5 input scripts, with the one or more equivalent HTML5 compliant tags [592] usually, marks the end of the step of transforming non-HTML5 input scripts to HTML5 output scripts [575]. However, in sophisticated embodiments of the process of automatic markup conversion [500], the step of transforming non-HTML5 input scripts to HTML5 output scripts [575] may include an additional sub step of developing one or more CSS files in compliance with CSS3 specification, and linking the generated CSS files with the HTML5 output scripts [596]. The purpose of this sub step is primarily to ensure that the aesthetics of the non-HTML5 input scripts are reflected as it is in the HTML5 output script. Simply stated, this sub step picks features such as the ‘look and feel’ of the non-HTML5 input script, the formatting of the non-HTML5 input scripts, the arrangement of content in the non-HTML5 input scripts, the font and stylizing of the content in the input Scripts etc., and mirrors them in the HTML5 output scripts.

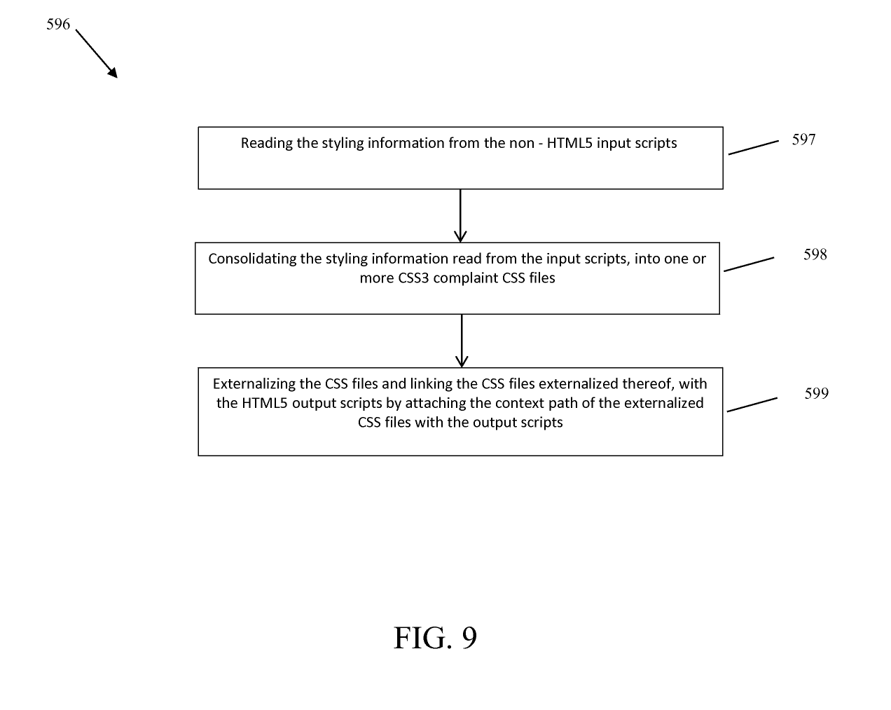

In accordance with the preferred embodiment of FIG. 9, the step of developing one or more CSS files in compliance with CSS3 specification, and linking the generated CSS files with the HTML5 output scripts [596] comprises reading the styling information from the one or more non-HTML5 input scripts, wherein the styling information is read from at least one of: a section or a tag with embedded styling information, within the input script [597]; consolidating the styling information read thereof, into one or more CSS files, wherein the CSS files are in compliance with CSS3 specification [598]; and externalizing the CSS files and linking the CSS files externalized thereof, with the one or more HTML5 output scripts by attaching the context path of the externalized CSS files with the output scripts [599].

Once the non-HTML5 input scripts are transformed into the HTML5 output scripts [575] then, the claimed process of markup conversion [500], performs the last step of post-validating the HTML5 output scripts [600], generated thereof. In accordance with the invention, this post-validating takes place in two stages viz. firstly, by checking that the HTML5 output scripts, so generated, are W3C standard compliant and, secondly, by sanctioning cross-browser backward compatibility in the HTML5 output scripts.

Person skilled in the art will acknowledge that the W3C (or the World Wide Web Consortium) is the main organization involved in writing standards for the web, including standards for markup languages. Accordingly, Person skilled in the art would understand that checking that the HTML5 output scripts are W3C standard compliant [600] is highly relevant in this context.

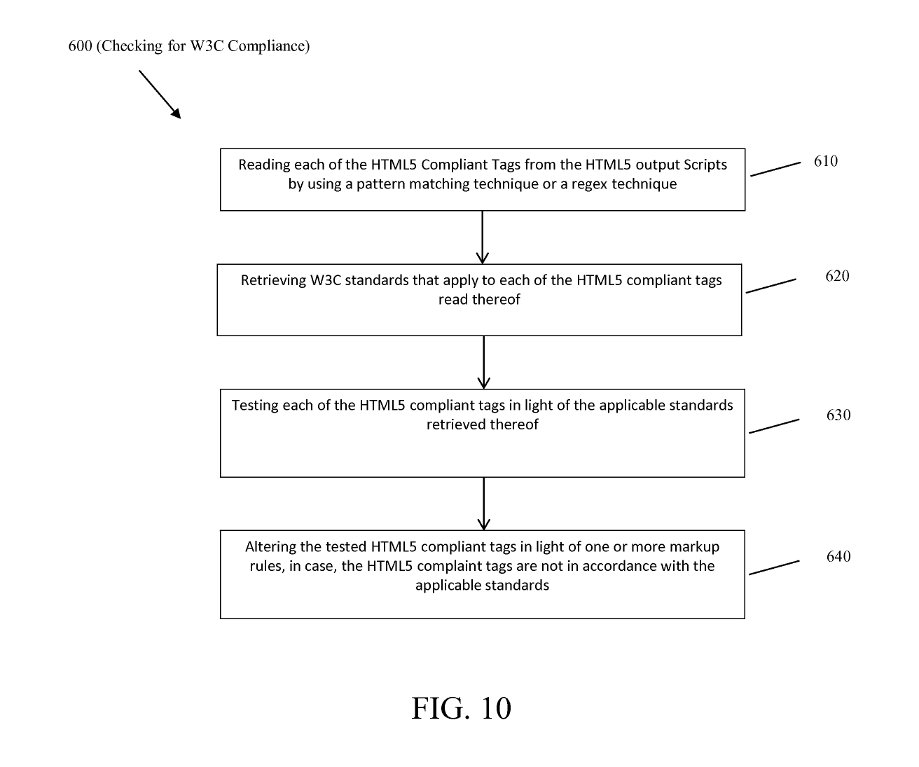

FIG. 10 provides a preferred embodiment of the step of post-validating the one or more equivalent HTML5 output scripts [600] by checking that the one or more equivalent HTML5 output scripts and the tags therein, are W3C standard compliant. The said embodiment comprises the sub steps of reading each of the one or more HTML5 Compliant Tags from the one or more HTML5 output Scripts by using at least one of: a pattern matching technique or a regex technique [610]; retrieving one or more W3C standards that apply to each of the one or more HTML5 compliant tags read thereof [620]; testing each of the one or more HTML5 compliant tags in light of the one or more applicable standards retrieved thereof [630]; and altering the one or more tested HTML5 compliant tags in light of one or more markup rules, in case, the one or more HTML5 complaint tags are not in accordance with the one or more applicable standards [640].

Likewise, the person skilled in the art will also acknowledge that cross-browser backward compatibility is necessary for equipping the HTML5 output scripts with the capability of running and executing on HTML5 compatible browsers, as well as the legacy browsers that are not compatible with HTML5. Some of these legacy browsers may include browsers such as include browsers such as Safari 3.1 and Firefox 2.0. Accordingly, person skilled in the art would understand that sanctioning cross browser compatibility [600] is also relevant in this context.

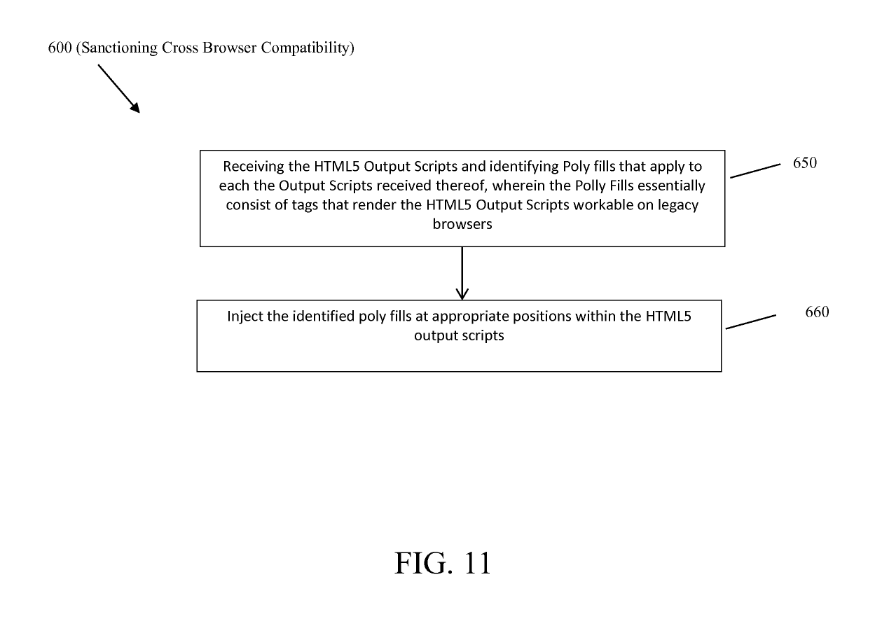

FIG. 11 is a preferred embodiment of the step of post-validating the one or more equivalent HTML5 output scripts [600] by sanctioning Cross Browser backward compatibility. The embodiment comprises receiving the one or more HTML5 Output Scripts and identifying one or more Poly fills that apply to each the Output Scripts received thereof, wherein the Polly Fills essentially consist of one or more tags that render the HTML5 Output Scripts workable on legacy browsers, further wherein the legacy browsers are those browsers that do not support HTML5 standard under ordinary conditions and include browsers such as Safari 3.1 and Firefox 2.0 [650]; and injecting the one or more identified poly fills at appropriate positions within the one or more HTML5 output scripts [660].

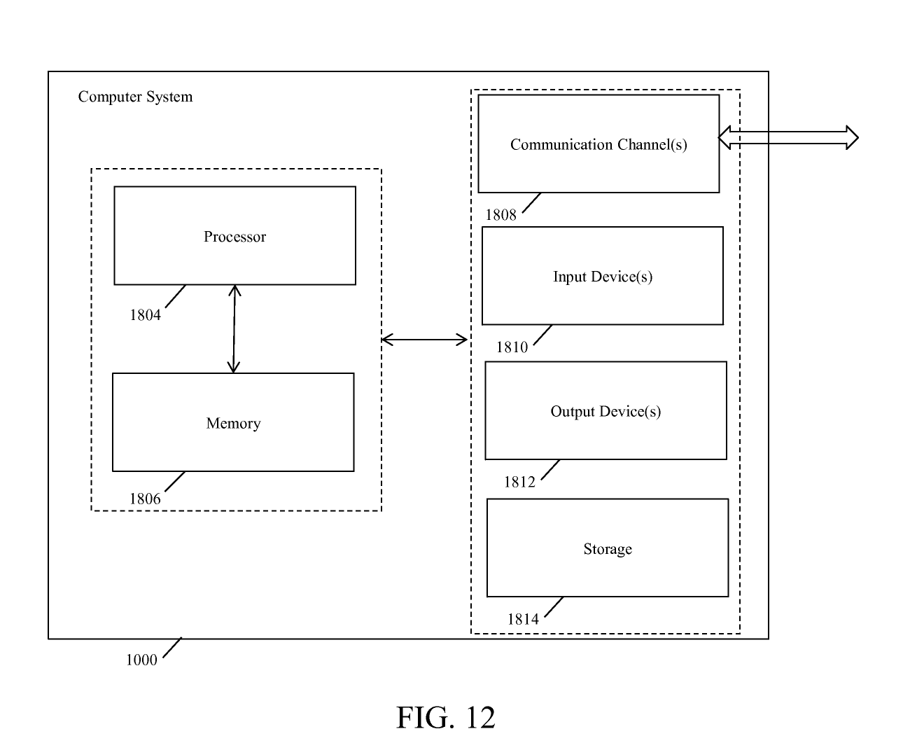

FIG. 12 illustrates an exemplary computer system [1000] in which various embodiments of the present invention may be implemented. The computer system [1000] comprising a processor [1004] and a memory [1006]. The processor [1004] executes program instructions and may be a real processor. The processor [1004] may also be a virtual processor. The computer system [1000] is not intended to suggest any limitation as to scope of use or functionality of described embodiments. For example, the computer system [1000] may include, but not limited to, a general-purpose computer, a programmed microprocessor, a micro-controller, a peripheral integrated circuit unit, and other devices or arrangements of devices that are capable of implementing the steps that constitute the method of the present invention. In an embodiment of the present invention, the memory [1006] may store software for implementing various embodiments of the present invention. The computer system [1000] may have additional components. For example, the computer system [1000] includes one or more communication channels [1008], one or more input devices [1010], one or more output devices [1012], and storage [1014]. An interconnection segment (not shown) such as a bus, controller, or network, interconnects the components of the computer system [1000]. In various embodiments of the present invention, operating system software (not shown) provides an operating environment for various software executing in the computer system [1000], and manages different functionalities of the components of the computer system [1000].

The communication channel(s) [1008] allow communication over a communication medium to various other computing entities. The communication medium provides data such as program instructions, or other data in a communication media. The communication media includes, but not limited to, wired or wireless methodologies implemented with an electrical, optical, RF, infrared, acoustic, microwave, bluetooth or other transmission media.

The input device(s) [1010] may include, but not limited to, a keyboard, mouse, pen, joystick, trackball, a voice device or any another device that is capable of providing input to the computer system [1000]. In an embodiment of the present invention, the input device(s)

may be a sound card or similar device that accepts audio input in analog or digital form. The output device(s) [1012] may include, but not limited to, a user interface on CRT or LCD, printer, speaker, CD/DVD writer, or any other device that provides output from the computer system [1000].

The storage [1014] may include, but not limited to, magnetic disks, magnetic tapes, CD-ROMs, CD-RWs, DVDs, flash drives or any other medium which may be used to store data and may be accessed by the computer system [1000]. In various embodiments of the present invention, the storage [1014] contains program instructions for implementing the described embodiments.

The present invention may suitably be embodied as a computer program product for use with the computer system [1000]. The method described herein is typically implemented as a computer program product, comprising a set of program instructions which is executed by the computer system [1000] or any other similar device. The set of program instructions may be a series of computer readable codes stored on a tangible medium, such as a computer readable storage medium (storage [1014]), for example, diskette, CD-ROM, ROM, flash drives or hard disk, or transmittable to the computer system [1000], via a modem or other interface device, over either a tangible medium, including but not limited to optical or analogue communications channel(s) [1008]. The implementation of the invention as a computer program product may be in an intangible form using wireless techniques, including but not limited to microwave, infrared, blue tooth or other transmission techniques. These instructions may be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

In relation to the preceding specification, it is re-iterated that the present disclosure and its advantages have been described with reference to exemplary embodiments and that, a person of ordinary skill in the art would appreciate that various modifications and changes may be made, without departing from the scope of the present disclosure, as set forth in the appended claims and their equivalents. Furthermore, it is re-emphasized that the preceding specification and figures are to be regarded as illustrative examples of the present disclosure, rather than in restrictive sense. All such possible modifications are intended to be included within the scope of present disclosure.

1. An automatic markup converter, wherein the markup converter comprises:
an analyzer module, wherein the analyzer module—
receives one or more non-HTML5 input scripts from a legacy application, and
examines, preliminarily, the one or more non-HTML5 input scripts and extracts critical markup information pertaining to the HTML5 non-compliant tags committed in the input scripts; and
a compliance module, logically connectible with the analyzer module, wherein the compliance module—
transforms the one or more non-HTML5 input scripts into one or more equivalent HTML5 output scripts, and
post-validates the one or more equivalent HTML5 output scripts by (a) checking that the HTML5 compliant tags present in the one or more equivalent HTML5 output scripts are W3C compliant, and (b) sanctioning Cross Browser backward compatibility by injecting Poly Fills into the one or more HTML5 output scripts;
wherein the analyzer module and the compliance module work in conjunction with a dynamic rule book, further wherein the dynamic rule book comprises one or more markup rules in accordance with which one or more actions are performed by the analyzer module and/or the compliance module.

2. The system of claim 1 wherein, the analyzer module receives at least one of: a non-HTML5 static script such as a static HTML script or a Java script, or a non-HTML5 dynamic script such as a server side scripts in J2EE and .NET or a Free Marker scripts, further wherein the non-HTML5 input scripts correspond to file formats including .jsp, .html, .ftl, .asp, .aspx, .xml, .xsl, .war, .ear, .zip, .ascx, .vb and .js.

3. The system of claim 1 wherein, the analyzer module examines, preliminarily, the one or more non-HTML5 input scripts and extracts critical markup information by:
identifying all the tags in the one or more non-HTML5 input scripts by applying at least one of: a pattern matching technique or a regex technique;
classifying all the identified tags as HTML5 Compliant Tags and HTML5 Non-Compliant Tags by validating the identified tags against one or more markup rules from the Dynamic Rule Book; and
receiving the classified tags, separately in two distinct lists and utilizing the lists for one or more purposes including reporting HTML5 compliance status of the one or more input scripts.

4. The system of claim 1, wherein the compliance module transforms the one or more non-HTML5 input scripts into one or more equivalent HTML5 output scripts by:
receiving the one or more non-HTML5 input scripts from the analyzer module;
perusing the one or more non-HTML5 input scripts and identifying one or more code snippets wherein, the code snippets comprise one or more tags which are not to be affected by the markup converter;
logically separating the one or more identified code snippets from the one or more non-HTML5 input scripts so as to obtain the code snippets and one or more remaining input scripts as distinct inputs;
accepting the one or more remaining input scripts as input and, reading the one or more HTML5 non-compliant tags committed therein;
generating an equivalent HTML5 compliant tag for each of the read one or more HTML5 non-compliant tags;
substituting the one or more HTML5 non-compliant tags in the non-HTML5 input scripts, with the one or more equivalent HTML5 compliant tags generated thereof, so as to obtain the one or more equivalent HTML5 output scripts; and
developing one or more CSS files in compliance with CSS3 specification, and linking the generated CSS files with the HTML5 output scripts, wherein the generated CSS files contain styling information describing the looks and formatting of the one or more HTML5 output scripts.

5. The system of claim 4 wherein, the compliance module peruses the one or more non-HTML5 input scripts and identifies one or more code snippets by:
receiving one or more instructions wherein, the instructions are at least one of: a pre-determined system instruction or a pre-determined manual instruction;
utilizing the one or more instructions to determine one or more code snippets within the non-HTML5 input scripts, wherein the code snippets comprise one or more tags that are not to be affected by the markup converter; and
introducing one or more labels in the non-HTML5 input scripts and demarcate, clearly, the one or more code snippets.

6. The system of claim 4 wherein, the compliance module generates an equivalent HTML5 compliant tag for each of the read one or more HTML5 non-compliant tags by:
reading, individually, each one or more HTML5 non-compliant tags from the one or more non-HTML5 input scripts, using at least one of: a pattern matching technique or a regex technique; and
converting each of the read one or more HTML5 non-compliant tags into one or more equivalent HTML5 compliant tags by applying one or more markup rules from the dynamic rule book.

7. The system of claim 4 wherein, the compliance module develops one or more CSS files in compliance with CSS3 specification, and links the generated CSS files with the HTML5 output scripts by:
reading the styling information from the one or more non-HTML5 input scripts, wherein the styling information is read from at least one of: a section within the input script or a tag with embedded styling information;
consolidating the styling information read thereof, into one or more CSS files, wherein the CSS files are in compliance with CSS3 specification; and
externalizing the CSS files and linking the CSS files externalized thereof, with the one or more HTML5 output scripts by attaching the context path of the externalized CSS files with the output scripts.

8. The system of claim 1 wherein, the compliance module checks that the HTML5 tags present in the one or more equivalent HTML5 output scripts are W3C compliant by a W3C Validator, further wherein the W3C Validator comprises the complete set of one or more W3C standards is configured to:
read each of the one or more HTML5 Compliant Tags from the one or more HTML5 output Scripts by using at least one of: a pattern matching technique or a regex technique;
retrieve one or more W3C standards which are applicable to each of the one or more HTML5 Compliant tags read thereof;
test each of the one or more HTML5 compliant tags in light of the one or more applicable standards retrieved thereof; and
redirecting the one or more HTML5 output scripts to the dynamic rule book for correction, in case, the test result for the one or more HTML5 complaint tags is not in accordance with the one or more applicable standards.

9. The system of claim 8 wherein, the W3C Validator redirects the one or more HTML5output scripts to the dynamic rule book for correction, further wherein, the Dynamic rule book—
receives the one or more HTML5 output Scripts from the W3C Validator;
alters the one or more HTML5 output Scripts and the tags therein, based on the one or more markup rules relating to W3C standard; and
pushes back the altered one or more HTML5 output scripts and the tags therein to the W3C Validator.

10. The system of claim 1 wherein, the compliance module sanctions Cross-Browser Backward compatibility by a Poly Filling Component, further wherein the Poly Filling Component is configured to—
receive the one or more HTML5 Output Scripts and identify one or more Poly fills apply to each the Output Scripts received thereof, wherein the Polly Fills essentially consist of one or more tags that render the HTML5 Output Scripts workable on legacy browsers, further wherein the legacy browsers are those
browsers that do not support the HTML5 standard under ordinary conditions and include browsers such as Safari 3.1 and Firefox 2.0; and
inject the one or more identified poly fills at appropriate positions within the one or more output scripts.

11. A method of automatic markup conversion, wherein the method comprises:
receiving one or more non-HTML5 input scripts from a legacy application;
examining, preliminarily, the one or more input scripts and extracting critical markup information pertaining to the HTML5 non-compliant tags committed in the input scripts;
transforming the one or more non-HTML5 input scripts into one or more equivalent HTML5 output scripts; and
post-validating the one or more equivalent HTML5 output scripts by (a) checking that one or more HTML5 tags present in the one or more HTML5 output scripts are W3C compliant, and (b) sanctioning Cross Browser backward compatibility by injecting Poly Fills into the one or more HTML5 output scripts.

12. The method of claim 11 wherein, receiving the one or more non-HTML5 input comprises receiving at least one of: a non-HTML5 static script such as a static HTML script or a Java scripts, or a non-HTML5 dynamic script such as a server side script in J2EE and .NET or Free Marker script, further wherein the non-HTML5 input scripts correspond to file formats including .jsp, .html, .ftl, .asp, .aspx, .xml, .xsl, .war, .ear, .zip, .ascx, .vb and .js.

13. The method of claim 11 wherein, examining, preliminarily, the one or more non-HTML5 input scripts and extracting critical markup information comprises:
identifying all the tags in the one or more non-HTML5 input scripts by applying at least one of: a pattern matching technique or a regex technique;
classifying all the identified tags as HTML5 Compliant Tags and HTML5 Non-Compliant Tags by validating the tags against one or more markup rules; and
receiving the classified tags, separately as two distinct lists and utilizing the lists for one or more purposes including reporting HTML5 compliance status of the one or more non-HTML5 input scripts.

14. The method of claim 11 wherein, transforming the one or more non-HTML5 input scripts into one or more equivalent HTML5 output scripts comprises:
perusing the one or more non-HTML5 input scripts and identifying one or more code snippets wherein, the code snippets comprise one or more tags which are not to be affected by the markup converter;
logically separating the one or more identified code snippets from the one or more non-HTML5 input scripts so as to obtain the one or more code snippets and the remaining input scripts as distinct inputs;
accepting the one or more remaining input scripts as input and, reading the one or more HTML5 non-compliant tags committed therein;
generating an equivalent HTML5 compliant tag for each of the read one or more HTML5 non-compliant tags;
substituting the one or more HTML5 non-compliant tags in the non HTML5 input scripts, with the one or more equivalent HTML5 compliant tags, so as to obtain the one or more equivalent HTML5 output scripts; and
developing one or more CSS files in compliance with CSS3 specification, and linking the generated CSS files with the HTML5 output scripts, wherein the generated CSS files contain styling information describing the looks and formatting of the HTML5 output scripts.

15. The method of claim 14 wherein, perusing the one or more non-HTML5 non-compliant input scripts and identifying one or more code snippets comprises:
receiving one or more instructions wherein, the instructions are at least one of: a pre-determined system instruction or a manual instruction;
utilizing the one or more instructions to determine one or more code snippets within the input scripts, wherein the code snippets comprise one or more tags that are not to be affected by the markup converter; and
introducing one or more labels in the HTML5 input scripts and demarcating, clearly, the one or more code snippets.

16. The method of claim 14 wherein, generating an equivalent HTML5 compliant tag for each of the read one or more HTML5 non-compliant tags comprises:
reading, individually, each one or more non-compliant HTML5 tags from the one or more non-HTML5 input scripts, using at least one of: a pattern matching technique or a regex technique; and
converting each of the read one or more non-compliant HTML5 tags into one or more equivalent HTML5 compliant tags by applying one or more markup rules.

17. The method as claimed in claim 14 wherein, developing one or more CSS files in compliance with CSS3 specification, and linking the generated CSS files with the HTML5 output scripts comprises:
reading the styling information from the one or more non-HTML5 input scripts, wherein the styling information is read from at least one of: a section or a tag with embedded styling information, within the input script;
consolidating the styling information read thereof, into one or more CSS files, wherein the CSS files are in compliance with CSS3 specification; and
externalizing the CSS files and linking the CSS files externalized thereof, with the one or more HTML5 output scripts by attaching the context path of the externalized CSS files with the output scripts.

18. The method as claimed in claim 11, wherein post-validating the one or more equivalent HTML5 output scripts by checking that the one or more equivalent HTML5 output scripts and the tags therein, are W3C standard compliant comprises:
reading each of the one or more HTML5 Compliant Tags from the one or more HTML5 output Scripts by using at least one of: a pattern matching technique or a regex technique;
retrieving one or more W3C standards that apply to each of the one or more HTML5 compliant tags read thereof;
testing each of the one or more HTML5 compliant tags in light of the one or more applicable standards retrieved thereof; and
altering the one or more tested HTML5 compliant tags in light of one or more markup rules, in case, the one or more HTML5 complaint tags are not in accordance with the one or more applicable standards.

19. The method of claim 11 wherein, post-validating the one or more equivalent HTML5 output scripts by sanctioning Cross Browser backward compatibility comprises—
receiving the one or more HTML5 Output Scripts and identifying one or more Poly fills that apply to each the Output Scripts received thereof, wherein the Polly Fills essentially consist of one or more tags that render the HTML5 Output Scripts workable on legacy browsers, further wherein the legacy browsers are those browsers that do not support HTML5 standard under ordinary conditions and include browsers such as Safari 3.1 and Firefox 2.0; and
injecting the one or more identified poly fills at appropriate positions within the one or more HTML5 output scripts.

20. A computer program product comprising a non-transitory computer-readable medium having computer-readable program code stored thereon, the computer-readable program code comprising instructions that, when executed by a processor, cause the processor to trigger an automatic markup converter, wherein the automatic markup converter comprising:
an analyzer module, wherein the analyzer module—
receives one or more non-HTML5 input scripts from a legacy application, and
examines, preliminarily, the one or more input scripts and extract critical markup information pertaining to the HTML5 non-compliant tags committed in the input scripts; and
a compliance module, logically connectible with the analyzer module, wherein the compliance module—
transforms the one or more non-HTML5 input scripts into one or more equivalent HTML5 output scripts, and
post-validates the one or more equivalent HTML5 output scripts by (a) checking that the HTML5 tags present in the one or more equivalent HTML5 output scripts are W3C compliant, and (b) sanctioning Cross Browser backward compatibility by injecting Poly Fills into the one or more HTML5 output scripts;
wherein the analyzer module and the compliance module work in conjunction with a dynamic rule book comprising one or more markup rules in accordance with which one or more actions are performed by the analyzer module and/or the compliance module.
